(19) United States
(12) Patent Application Publication
(10) Pub. No.: US 2021/0143480 A1
(43) Pub. Date: May 13, 2021

(54) EUTECTIC SOLVENTS AS ELECTROLYTE/CATHOLYTE FOR SAFE AND HIGH PERFORMANCE LITHIUM SULFUR BATTERIES

(71) Applicant: THE TRUSTEES OF COLUMBIA UNIVERSITY IN THE CITY OF NEW YORK, New York, NY (US)

(72) Inventors: Yuan YANG, New York, NY (US); Qian CHENG, New York, NY (US); Weiheng XU, New York, NY (US)

(73) Assignee: THE TRUSTEES OF COLUMBIA UNIVERSITY IN THE CITY OF NEW YORK, New York, NY (US)

(21) Appl. No.: 17/156,799

(22) Filed: Jan. 25, 2021

Related U.S. Application Data
(63) Continuation of application No. PCT/US2019/043596, filed on Jul. 26, 2019.
(60) Provisional application No. 62/703,631, filed on Jul. 26, 2018.

(51) Int. Cl. H01M 10/0569; H01M 10/052

(52) U.S. Cl. CPC H01M 10/0569; H01M 2300/0037; H01M 10/052

(57) ABSTRACT

Disclosed is an electrolyte in communication with an anode and a cathode of a battery. The electrolyte includes a eutectic solvent including ε-caprolactam (CPL), acetamide, imidazole, urea, amide, o-toluic acid, benzoic acid, furoic acid, quaternary ammonium type salts, or combinations thereof in equimolar concentration; and a sulfide. The sulfide including an alkali sulfide, an alkali polysulfide, or combinations thereof. Also disclosed is a battery including an anode and a cathode and the aforementioned electrolyte.

### CROSS REFERENCE TO RELATED APPLICATIONS

This application is a continuation of International Patent Application No. PCT/US2019/043596, filed Jul. 26, 2019, which is a non-provisional application of, and claims priority benefit to, U.S. Provisional Patent Application No. 62/703,631, filed on Jul. 26, 2018, the entirety of which are incorporated herein by reference.

### FIELD OF THE INVENTION

The present invention is generally directed to electrochemical energy storage devices and in particular, is directed to electrolytes including a eutectic solvent and batteries including electrolytes including a eutectic solvent.

### BACKGROUND

The lithium sulfur battery is attractive for next-generation energy storage as it has much higher theoretical energy density than state-of-the-art lithium-ion batteries. Lithium sulfide (Li—S) batteries are an emergent battery technology with high specific capacitance and energy density. Li—S batteries are leaders in the battery revolution to advance energy storage technology. The lithium-sulfur battery is a promising candidate for next-generation energy storage systems, as it has high theoretical energy density of 2500 Wh·kg⁻¹ from both aspects of safety and performance.

In Li—S batteries, sulfur undergoes a two-electron process, which renders it a high specific capacity of 1675 mAh·g⁻¹. However, this two-electron process is complicated and includes multiple steps, ranging from solid sulfur, to soluble long-chain polysulfides (e.g. Li₂S₈, Li₂S₆ and Li₂S₄), and precipitation of solid Li₂S/Li₂S₂. Such a complicated process results in multiple mechanisms to deteriorate cycling performance, such as shuttle effect, uncontrollable deposition of insulating Li₂S, and large volume change. The large volume changes from soluble high-order polysulfides to solid Li₂S₂/Li₂S and the uncontrollable deposition of Li₂S₂/Li₂S significantly deteriorate its cycling life and increase voltage polarization. Recently, significant efforts have been devoted to trap long-chain soluble polysulfides to mitigate the shuttle effect and their random diffusion, including confined carbon framework, electrode additives and physical/chemical adsorptions. On the other hand, much less attention has been paid to Li₂S₂ and Li₂S, which account for three quarters of the total theoretical capacity. The random deposition of insulating Li₂S causes large voltage polarization and suppresses continuous reduction of polysulfides, which remarkably reduces charge capacity. FIG. 1 shows a conventional lithium sulfur battery with dead Li₂S precipitated non-uniformly on the current collector. The large volume change (infinite from polysulfide to sulfide) also causes pulverization and mechanical failure of electrode materials. Recently, it is shown that modification of carbon electrodes to form uniform Li₂S₂/Li₂S deposition is an effective approach to mitigate this issue.

To become viable, electrolyte materials for Li—S batteries must overcome solubility and safety issues while retaining high conductivity and cycling stability. As mentioned above, lithium-sulfur batteries have a high theoretical energy density of 2500 Wh kg⁻¹. As such, this may significantly improve the efficiency and safety of Li—S battery design for industrial and commercial applications.

But Li—S batteries need improvement on performance, safety and cycling lifetime. Li—S batteries rely on electrolytes to shuffle ions from cathode to anode compartments that continue to experience cycling limitations, solubility issues, and flammability concerns. Several performance, safety and cycling concerns are due to the electrolyte used in Li—S batteries. Electrolyte choice for battery devices is critical to ensure the optimum transfer of ions from the anode to the cathode departments. Most electrolyte materials are organic solvents that can be easily ignited and cause the device to catch fire. Most ionic liquids or solid electrolytes are costly for production. Li—S batteries experience low cycling lifetimes caused by insoluble Li₂S₂/Li₂S in most electrolytes.

An alternative feasible approach to solve these issues is to render Li₂S₂/Li₂S soluble, so that no solid deposition, voltage polarization, and mechanical stress will occur during battery cycling, and thus stable cycling performance is expected. Recently, NH₄-based additive was reported to enhance the dissolution of Li₂S in electrolyte, improving the cycling performance of Li—S batteries under lean electrolyte.

### SUMMARY

To address at least the aforementioned challenges, in some embodiments, the present disclosure is directed to an electrolyte with an improved ability to dissolve to lithium polysulfides and sulfides (Li₂S₈—Li₂S). In some embodiments, the electrolyte includes a eutectic solvent. In some embodiments, the electrolyte includes a eutectic solvent and a sulfide. In some embodiments, the electrolyte includes an ε-caprolactam/acetamide based eutectic electrolyte with improved ability to dissolve lithium polysulfides and sulfides (Li₂S₈—Li₂S).

In some embodiments, an electrolyte is in communication with an anode and a cathode of a battery, the electrolyte comprising: a eutectic solvent including ε-caprolactam (CPL), acetamide, imidazole, urea, amide, o-toluic acid, benzoic acid, furoic acid, quaternary ammonium type salts, or combinations thereof in equimolar concentration. In some embodiments, the electrolyte further comprises an additional species including dioxolane (DOL) and dimethoxyethane (1,2 DME), bis(X-methoxyethoxy)ethane (TEGDME), lithium bis-(trifluoromethanesulfonyl)imide (LiTFSI), LiNO₃, or combinations thereof, wherein the additional species is at about a 1:1 weight ratio with the euctectic solvent.

In some embodiments of the electrolyte, the eutectic solvent includes equimolar concentrations of CPL and acetamide.

In some embodiments, the electrolyte further comprises a sulfide. In some embodiments, the sulfide includes an alkali sulfide, an alkali polysulfide, or combinations thereof. In some embodiments, the alkali sulfide and alkali polysulfide includes Li₂S, Li₂S₂, Li₂S₃, Li₂S₄, Li₂S₅, Li₂S₆, Li₂S₇, Li₂S₈, Na₂S, Na₂S₃, Na₂S₄, Na₂S₅, Na₂S₆, Na₂S₇, Na₂S₈, or combinations thereof. In a particular embodiment, the sulfide is Li₂S. In some embodiments of the electrolyte, the concentration of sulfide in the eutectic solvent is between about 0.2 M to about 0.4M.

It is contemplated that the electrolyte may be used in or with any kind of electrochemical energy storage device.

In some embodiments, the invention is directed to a battery including the aforementioned electrolyte. In one embodiment, the invention is directed to a battery comprising: an anode; a cathode; and an electrolyte in communication with the anode and the cathode; wherein the electrolyte comprises: a eutectic solvent including ε-caprolactam (CPL), acetamide, imidazole, urea, amide, o-toluic acid, benzoic acid, furoic acid, quaternary ammonium type salts, or combinations thereof in equimolar concentration.

In some embodiments of the battery, the electrolyte further comprises: an additional species including dioxolane (DOL) and dimethoxyethane (1,2 DME), bis(X-methoxyethoxy)ethane (TEGDME), lithium bis-(trifluoromethanesulfonyl)imide (LiTFSI), LiNO₃, or combinations thereof, wherein the additional species is at about a 1:1 weight ratio with the eutectic solvent.

In some embodiments of the battery, the eutectic solvent includes equimolar concentrations of CPL and acetamide.

In some embodiments of the battery, the electrolyte further comprises a sulfide. In some embodiments of the battery, the sulfide includes an alkali sulfide, an alkali polysulfide, or combinations thereof. In some embodiments, the alkali sulfide and alkali polysulfide includes Li₂S, Li₂S₂, Li₂S₃, Li₂S₄, Li₂S₅, Li₂S₆, Li₂S₇, Li₂S₈, Na₂S, Na₂S₃, Na₂S₄, Na₂S₅, Na₂S₆, Na₂S₇, Na₂S₈, or combinations thereof. In a particular embodiment, the sulfide is Li₂S. In some embodiments of the battery, the concentration of sulfide in the eutectic solvent is between about 0.2 M to about 0.4M.

In some embodiments of the battery at least one of the anode and cathode comprises a coating of TiO₂ nanoparticles. In some embodiments, the battery has a capacity of 1360 mAh·g⁻¹.

It is contemplated that the battery may be any type of battery, including, but not limited to Li—S batteries.

The invention is not limited to the aforementioned characteristics, and is further described in more detail in the following detailed description, examples and claims and illustrated in the appended drawings. It is contemplated that any or all of the various embodiments described in the instant application can be used together or separately and reconfigured while still maintaining the spirit of the invention.

### BRIEF DESCRIPTION OF THE DRAWINGS

FIG. 1 illustrates conventional lithium sulfur battery using a conventional electrolyte, with dead Li₂S precipitated non-uniformly on the current collector.

FIG. 2 illustrates a lithium sulfur battery using an electrolyte according to embodiments herein.

FIG. 3 is a graph illustrating solubility of Li₂S.

FIG. 4A-4D are graphs illustrating radial distribution functions. FIGS. 4A and 4B show Li—X and S—X radial distribution functions respectively for 0.4 M Li₂S in CPL/acetamide at molar ratio of 1:1. FIGS. 4C and 4D show Li—X and S—X radial distribution functions for 0.4 M Li₂S in DOL/DME at molar ratio of 1:1.

FIG. 5 is a graph illustrating lithium-lithium symmetric cell performance regarding the LiTFSI/CPL/acetamide/DOL/DME electrolyte.

FIG. 6 illustrates a charge/discharge curve of a carbon fiber/CPL/0.5 M LiTFSI in acetam-ide/DOL/DME (1:1:1:1)/lithium cell.

FIG. 7 illustrates a voltage profile as described in the Examples herein.

FIG. 8 illustrates cycling performance as described in the Examples herein.

FIG. 9 illustrates columbic efficiencies as described in the Examples herein.

FIG. 10 illustrates rate performance as described in the Examples herein.

These and other aspects of the invention are discussed in the detailed description and appended claims and abstract.

### DETAILED DESCRIPTION

In the following specification and the claims which follow, reference will be made to a number of terms, which shall be defined to have the following meanings. The singular forms “a”, “an” and “the” include plural referents unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value.

Ranges of numerical values, e.g., from about 2 to about 7, as used herein throughout the specification and claims, include all values falling within the range as well as the boundaries of the given range. As an example, the range of “from about 2 to about 7” includes the values 2 and 7 and every fraction there between, e.g., 2.05, 2.10, 2.12, etc.

Some embodiments of the systems and methods of the present disclosure are directed to an electrochemical energy storage device that includes one or more electrodes, e.g., an anode, a cathode, etc. In some embodiments, the system is a battery including one or more electrodes, i.e., an anode, a cathode, etc., and an electrolyte in communication with the one or more electrodes. The electrode can be made of any suitable material to facilitate reaction with the electrolyte to generate a current. In a particular embodiment, the system is a rechargeable battery. In particular, the system is a rechargeable Li—S battery having an anode and a cathode. In some embodiments, the anode is lithium or a lithium alloy and the cathode is a carbon based sulfur cathode.

In some embodiments, the electrolyte includes a eutectic solvent. In some embodiments, the eutectic solvent includes ε-caprolactam (CPL), acetamide, imidazole, urea, amide, o-toluic acid, benzoic acid, furoic acid, quaternary ammonium type salts, e.g., tetrabutylammonium-bromide, etc., or combinations thereof. In some embodiments, the solvents in the eutectic solvent have an equimolar concentration. In a particular embodiment, the eutectic solvent includes equimolar concentrations of CPL and acetamide. In another embodiment, the eutectic solvent includes equimolar concentrations of CPL and imidazole. In another embodiment, the eutectic solvent includes equimolar concentrations of acetamide and tetrabutylammonium-bromide. In some embodiments, the eutectic solutions are stable at room temperature for over 30 days.

Without wishing to be bound by theory, and now referring to FIG. 2, some embodiments of the present disclosure are directed to an electrolyte having eutectic solvent, including, in some embodiments, ε-caprolactam (CPL) and acetamide, which can dissolve all polysulfides and sulfide species (Li₂S₈ to Li₂S) to address issues discussed above. In contrast to traditional 1,3-dioxolane/1,2-dimethoxyethane (DOL/DME) electrolyte with low flash point (0-2° C.), the electrolytes consistent with embodiments of the present disclosure are much more difficult to be ignited, and thus can dramatically enhance battery safety.

In some embodiments the electrolyte includes a eutectic solvent and a sulfide. In some embodiments, the sulfide is a polysulfide. In some embodiments, the sulfide is an alkali sulfide, alkali polysulfide, or combinations thereof. In some embodiments, the sulfide includes lithium. In some embodiments, the sulfide includes sodium. In some embodiments, the sulfide includes Li₂S, Li₂S₂, Li₂S₃, Li₂S₄, Li₂S₅, Li₂S₆, Li₂S₇, Li₂S₈, Na₂S, Na₂S₃, Na₂S₄, Na₂S₅, Na₂S₆, Na₂S₇, Na₂S₈, and the like, or combinations thereof. In a particular embodiment of the electrolyte, the sulfide is Li₂S

In some embodiments, the concentration of sulfide in the eutectic solvent is approximately 0.2M to about 1M. In some embodiments, the concentration of sulfide in the eutectic solvent is approximately 0.2 M to about 0.4M. In some embodiments, the concentration of sulfide in the eutectic solvent is approximately 0.3M to about 0.5M. In some embodiments, the concentration of sulfide in the solvent is approximately 0.4M to about 0.6M.

In some embodiments, the electrolyte includes additional electrolyte species. In some embodiments, the additional species includes dioxolane (DOL) and dimethoxyethane (1,2 DME), bis(X-methoxyethoxy)ethane (TEGDME), or combinations thereof. In one embodiment the additional species includes DOL and DME.

In some embodiments, the additional species is at approximately a 0.5:1 to 1.5:1 weight ratio with the eutectic solvent. In some embodiments, the additional species is at approximately a 1:1 weight ratio with the eutectic solvent. In some embodiments, the additional species is at approximately a 0.5:1 to 1.5:1 weight ratio with the eutectic solvent/sulfide mixture. In some embodiments, the additional species is at approximately a 1:1 weight ratio with the eutectic solvent/sulfide mixture. In a particular embodiment, the electrolyte includes a eutectic solvent of CPL and acetamide in equimolar concentrations and additional species of DOL and DME, where the additional species is at a 1:1 weight ratio with the eutectic solvent.

In some embodiments, the one or more additional species are included to improve viscosity of the electrolyte. In other embodiments, the one or more additional species are included to improve electrolyte performance, and include such species as ionic conductivity enhancers, passivators, and the like. In some embodiments, the one or more additional electrolyte species include lithium bis-(trifluoromethanesulfonyl)imide (LiTFSI), LiNO₃, or combinations thereof.

In some embodiments, the viscosity of eutectic solvent is optimized to demonstrate high electrochemical performance. In one embodiment, the eutectic solvent includes a CPL/acetamide and is optimized to demonstrate high electrochemical performance. In some embodiments, the eutectic solvent was mixed with DOL/DME to obtain a balance between Li₂S solubility, viscosity and non-flammability. In one particular embodiment, the electrolyte is a mixture of CPL/acetamide with DOL/DME at 1:1 weight ratio, and Li₂S is 0.2 M.

In some embodiments, 1.2 M lithium bis-(trifluoromethanesulfonyl)imide (LiTFSI) and 0.1 M LiNO₃ are also added to the electrolyte to enhance ionic conductivity and passivate lithium surface, respectively.

In some embodiments, the electrolyte can further include conventional electrolytes. In some embodiments, the electrolyte includes a eutectic solvent including CPL/acetamide combined with conventional electrolytes in essentially any desired ratio, enabling an electrolyte with suitable ionic conductivity and safety to be tailored depending on requirement.

It is contemplated that the electrolyte is made by mixing or combining the components in any manner in which electrolytes can be mixed or combined.

In some embodiments, the electrolyte can reach a capacity of 1360 mAh·g⁻¹ at 0.1 C with over 90% capacity retention rate in 40 cycles. In some embodiments, the electrolyte has reduced flammability as compared to conventionally used electrolytes. In some embodiments, by using the electrolyte including the eutectic solvent which can dissolve all sulfides species, high specific capacity of 1360 mAh·g⁻¹ and a capacitance retention of 88% over 40 cycles can be achieved at 0.1° C. In some embodiment, the electrolyte is stable without any precipitate for at least 45 days.

In some embodiments, when the electrolyte is used in a lithium sulfur battery, volume expansion, uncontrollable deposition, and voltage polarization, can be mitigated. Without wishing to be bound by theory, the eutectic solvents of the present disclosure display improved ability to dissolve the whole sulfide family, including Li₂S₂/Li2_{S}, which are not dissolved in traditional ether based electrolyte. In some embodiments, the electrolyte can also dissolve the sodium sulfides family (Na₂S—Na₂S₈) up to 1.0 M. Given the foregoing, the electrolytes can be used applications in lithium sulfur batteries, sodium sulfur batteries and Li/Na sulfur flow batteries.

In some embodiments, the invention is directed to a battery including the aforementioned electrolyte, the battery including at least one electrode. In some embodiments, the battery includes an anode, a cathode and an electrolyte according to any of the embodiments herein. In some embodiments, at least one of the anode and cathode includes an electrode additive. In some embodiments, the electrode additive is TiO₂ nanoparticles. In a particular embodiment, at least one of the anode and cathode includes a coating of TiO₂ nanoparticles.

With the further addition of TiO₂ nanoparticles on carbon electrode, stable capacity retention of 81% over 100 cycles can be achieved. In some embodiments, the average Coulombic efficiency of the TiO₂ coated electrodes is around 99.5%.

It is contemplated that the electrolyte disclosed herein is advantageous due to its high safety, low cost, extraordinary performance and adjustable compositions. The electrolyte can be either used in ordinary secondary batteries or large scale energy storage.

The following examples are included herein to provide information on certain aspects of the invention and are not meant to limit the invention to the exemplified formulations.

### Examples

### Method of Making an Electrolyte According to Embodiments Herein

Electrolytes according to embodiments described herein was made and tested according to the methods described herein. All of the reagents used in this experiment were analytic grade purity and were used as received.

In an argon filled glove box, 1 mole of ε-Caprolactam (99% purity, Sigma Aldrich) and 1 mole of Acetamide (99% purity, Sigma Aldrich) were dried under argon in the glovebox overnight at 50° C. before use. They were then mixed and stirred at 100° C. for 15 minutes. After a clear mixture was obtained, it was cooled to room temperature and was rested in vacuum for 6 hours to remove any absorbed gas.

In an argon filled glove box, 0.4M of Li₂S (99.98%, Sigma Aldrich) was mixed with the CPL/acetamide eutectic solvent and the mixture was stirred at 90° C. for 6 hours until fully dissolved.

2.4 M of lithium bis(trifluoromethanesulfonyl)imide, LiTFSI (99.95%, Sigma Aldrich) and 0.2 M of LiNO₃ (reagent plus, Sigma Aldrich) were dissolved in 1,3-dioxolane (1,3 DOL, 99.5%, Sigma Aldrich) and 1,2-Dimethoxyethane (1,2 DME, anhydrous, 99.5%, Sigma Aldrich) with 1:1 volume ratio overnight at 40° C. CPL/acetamide/Li₂S was mixed with the DOL/DME electrolyte in a weight ratio of 1:1 at 40° C. for 3 hours.

Preparation of a TiO₂ coated carbon electrode. Carbon paper (thickness 0.19 mm, bulk density 0.44 g/cm³, Fuel Cell Earth) was first soaked in 28%/wt. nitric acid (Fisher scientific) at 40° C. overnight to increase the hydrophile of carbon paper. 0.075 M of titanium(IV) butoxide (97%, Sigma Aldrich) was diluted by isopropyl alcohol (99%, Pharmco-Aaper), and was gently stirred for 5 minutes. The carbon fiber paper was dipped into this solution and was dried at 70° C. for 2 hours. The dipping process was repeated for four times in order to obtain a uniform layer. At last, the coated carbon fiber paper was heated at 600° C. for 2 hours in a tube furnace (Lindberg Blue M) under the flow of nitrogen gas to increase the crystallinity of TiO₂.

Electrochemistry Measurements. CR2032-type coin cells (MTI Corp.) were used during coin cell assembling. Lithium chip (99.9% purity, 0.6 mm thick, MTI Corporation) with a diameter of 12.7 mm were used as anode. It was first soaked in 0.5 M LiTFSI in DOL/DME (v/v=1:1) containing 2 wt % LiNO₃ for 1.5 hours to obtain a passivation layer on the lithium surface. Carbon paper (thickness 0.19 mm, bulk density 0.44 g/cm³, Fuel Cell Earth) with a diameter of 9 mm was used as the current collector. 20 μL of the catholyte was added into the carbon paper and the weight was recorded. One porous polypropylene/polyethylene separator (25 μm thick, Celgard) was sandwiched between the carbon paper and the lithium chip to avoid direct contact. Galvanostatic cycling electrochemistry measurement was performed on Landt battery tester and electrochemical impedance spectroscopy test was performed on Bio-logic VMP3. For all cells, the first cycle is charged and discharged at 0.1 C to allow the full activation of Li₂S. The voltage range for cycling is 1.8-2.7 V, and 1 C rate is 1650 mA g⁻¹.

EDX Characterization for precipitation examination. The carbon current collector after cycling was washed with DOL/DME with 1:1 volume ratio for three times to dissolve the polysulfide as well as the eutectic solvent. Then the carbon fiber paper was dried in vacuum for 5 hours. SEM (Light Zeiss Microscope) was used to examine the surface of carbon paper and EDX (Broker) was used for elemental analysis. The accelerated voltage of electron gun is 15 kV.

Simulation. Ab initio molecular dynamics (AIMD) simulations where conducted to investigate the dynamics of Li₂S solvated in CPL/acetamide and DOL/DME electrolytes. The interactions between the valence electrons and the ionic cores are calculated by the projector augmented wave pseudopotentials (PAW) method. The electron-electron exchange correlations are described by the Perdew-Burke-Ernzerhof generalized-gradient-approximation (PBE-GGA) with a plane wave energy cutoff of 400 eV and a Gaussian smearing width of 0.05 eV. The Brillouin zone is sampled using the F-point only. The convergence criterion for the electronic self-consistent loop in each dynamic step is set to 1×10⁻⁴ eV. All the simulations are performed under constant atom number, volume, and temperature (NVT) ensemble at 300 K using an Nose-Hoover thermostat. Hydrogen masses are changed to tritium to allow the use of larger time steps (1 fs in this study). The Vienna Ab Initio Simulation Package (VASP) software was used to perform the AIMD simulations.

Although the Li—S battery electrolyte usually contains a mixture of solvents along with Li-salts and other additives, this simulation was simplified by removing the presence of Li-salts and consider pure CPL/acetamide and DOL/DME mixtures. In the simulations, ion pairs of two Li⁺ ions and one S²⁻ dianion are positioned in the middle of cubic simulation cells. Solvent molecules at molar ratio of 1:1 are randomly packed around the ion pairs based on the solvent densities using PACKMOL software. To match 0.4 M solubility in the experiments, the CPL/acetamide system has 30 solvent molecules in a 15.95×15.95×15.95 Å³ simulation box, and the DOL/DME system has 28 solvent molecules in a 15.93×15.93×15.93 Å³ cell. Before running the AIMD simulations, the initial configurations are relaxed by performing energy minimization in classical molecular dynamics using GROMACS. An AIMD simulation includes 5 ps of equilibration and 10 ps of production run. Radial distribution functions (RDF) and simulation snapshots for solvation structure characterization are obtained using Visual Molecular Dynamics (VIVID). Bader charge analysis was applied to estimate the partial charges of different atoms in the solvent molecules.

High specific capacity of 1360 mAh·g⁻¹ was achieved at 0.1 C (165 mA·g⁻¹), and the capacity remained at 1193 mAh·g⁻¹ over 40 cycles. With the further addition of TiO₂ nanoparticles, stable capacity retention of 81% over 100 cycles was achieved. Moreover, this eutectic electrolyte was much less flammable, even not ignitable in contact with fire, in contrast to immediate firing of the conventional 1,3-dioxolane/1,2-dimethoxyethane (DOL/DME) electrolyte (flash point of 0-2° C.).

Solubility tests shows that up to 0.7 M of Li₂S were dissolved in this solvent at room temperature, and the solution is clear even after two months (FIG. 3). The mixture of CPL/acetamide was prepared by heating the mixture of two chemicals at 50° C. for 15 minutes, followed by degassing in vacuum at room temperature. Then 0.7 M Li₂S was added into the mixture and heated at 90° C. for 6 hours. The solution is clear without precipitation after storing at room temperature for 60 days.

In contrast, the solubility of Li₂S in a conventional DOL/DME electrolyte is negligible. The Li₂S/DOL/DME solution was stirred for 3 days at 50° C., and Li₂S/CPL/acetamide solution was stirred overnight at 90° C. The Li₂S/DOL/DME solution resulted in a cloudy solution as compared to a clear solution for an electrolyte according to embodiments herein which included Li₂S/CPL/acetamide.

To exclude the possibility that Li₂S forms colloid in the solvent, Tyndall effect test was conducted on both pure eutectic CPL/acetamide solvent and 0.4 M Li2S dissolved inside, with a 0.2 mg·ml−1 graphene oxide (GO) dispersion as a control sample. Negligible scattering is observed in both solutions. The points in the Tyndall effect test were randomly chosen to analyze the pixel intensity in order to compare the diffracted intensity. Results are shown in Table 1 below.

TABLE 1
The average intensity in regions with
and without Tyndall effect scattering.

| | Average Intensity | Intensity Difference |
|---|---|---|
| GO | 22.2 | 22.4 |
| GO- in laser beam | 44.6 | |
| 0.4M Li₂S | 136.3 | 0.8 |
| 0.4M Li₂S - in laser beam | 137.1 | |
| Pure solvent | 139.3 | 1 |
| Pure solvent - in laser beam | 140.3 | |

Raman spectrum further confirms the full dissolution of pure Li₂S, CPL/acetamide, 0.4 M Li₂S/CPL/acetamide (FIG. 3). The signature Raman peak of Li₂S at 375 cm⁻¹ is no longer observed in 0.4 M Li₂S in the eutectic solvent. Besides Li₂S, such solvent also shows good solubility for Li₂S₂ to Li₂S₈ with stability over 400 hours, which is a positive indicator for the dissolution of all polysulfide/sulfide species.

Ab initio molecular dynamics (AIMD) simulations were performed for 0.4 M Li₂S in CPL/acetamide and DOL/DME electrolytes. Intermolecular interactions leading to solubility difference were elucidated by the radial distribution functions (RDF) between Li₂S and the solvent molecules. The large peaks in FIGS. 4A-D indicate strong coordination between oxygen and lithium ions for both solvents. FIGS. 4A and 4B show Li—X and S—X radial distribution functions respectively for 0.4 M Li₂S in CPL/acetamide at molar ratio of 1:1. FIGS. 4C and 4D show Li—X and S—X radial distribution functions for 0.4 M Li₂S in DOL/DME at molar ratio of 1:1. X here represents different atoms in the solvent molecules.

### Electrolytes Including Additional Species

An electrolyte containing Li₂S/CPL/acetamide and DOL/DME at 1:1 weight ratio was made. The overall electrolyte contains 0.2 M of Li₂S, 1.2 M of LiTFSI, and 0.1 M of LiNO₃. Li₂S/CPL/acetamide and DOL/DME/LiTFSI/LiNO₃ were prepared separately and mixed together. The mixture was stirred for 2 hours at 40° C. until uniformly mixed at 40° C. A clear solution was generated right after mixing. After the electrolyte was stored after 45 days, the solution remained clear. No precipitation of either Li₂S or sulfur solid was observed after 45 days of storage.

Such electrolyte showed reasonable stability against lithium metal and in the voltage window of the cathode. A lithium/lithium symmetric cell with the above electrolyte containing no Li₂S showed steady cycling for over 1000 hours at 0.1 mA·cm⁻². No increasing voltage polarization was observed, as shown by the lithium-lithium symmetric cell performance regarding the LiTFSI/CPL/acetamide/DOL/DME electrolyte from FIG. 5. The current density was 0.1 mA·cm⁻², and charge/discharge time was two hours per cycle. The cell showed great stability without any increase in the internal resistivity for over 1000 hours.

Without Li₂S, the electrolyte exhibited very little capacity (<0.003 mAh·g⁻¹ catholyte) between 1.8 and 2.8 V vs Li/Li+, indicating no redox reaction due to electrolyte in this voltage window. FIG. 6 shows the charge/discharge curve of a carbon fiber/CPL/0.5 M LiTFSI in acetam-ide/DOL/DME (1:1:1:1)/lithium cell. 20 μl of electrolyte was added on the carbon fiber current collector as the cathode. The capacity was ˜3 μAh·g⁻¹, which shows no redox reaction of such electrolyte in the voltage range of sulfur cathode.

### Evaluation of Battery Performance

To evaluate battery performance, the Li₂S/CPL/acetamide and DOL/DME/LiTFSI/LiNO₃ containing 0.2 M Li₂S was tested with lithium metal as anode. The charging cut-off was 2.7 V to avoid the precipitation of solid. The discharging cut-off was set to 1.8 V. From the voltage profile shown in FIG. 7, two plateaus corresponding to high-order polysulfides and Li₂S₂/Li₂S, similar to conventional Li—S batteries are seen. Cycling performance at 0.1, 0.3 and 0.5 C are shown in FIG. 8. At 0.1 C, the specific capacity based on sulfur mass reaches 1258 mAh·g−1 in the first cycle, and then slowly increases to 1360 mAh·g−1, which indicates 93% utilization of the theoretical capacity (1465 mAh·g−1, Li₂S to Li₂S₈). After 40 cycles, the capacity still remains at 1193 mAh·g−1, 91.4% capacity retention compared to the first cycle. In comparison, when ammonium additive is used to dissolve Li₂S, capacity retention of only 50% was reported in the first 40 cycles. This indicates that the high solubility of Li₂S avoids the deposition of the insulating Li₂S and corresponding mechanical stress inside, and thus improves the cycling performance.

At higher rates of 0.3 C and 0.5 C, the initial capacities were 953 and 531 mAh·g⁻¹, with capacity retentions of 90.3% and 94.8% after 40 cycles, respectively (FIG. 8). The average coulombic efficiencies of all three rates were above 99%. Coulombic efficiencies of the cells in FIG. 8 at 0.1, 0.3, and 0.5 C are shown in FIG. 9. The average coulombic efficiencies (3rd cycle to 40th cycle) for all three cells were above 99%.

The rate performance test of FIG. 9 shows that the capacity gradually steps down with increasing current density. EIS of the cell charged to 2.3 V at 1st, 5th, 20th and 40th cycles, corresponding to Li₂S₂ phase, 1 C=1650 mA·g−1 (per sulfur) for all data, is shown in FIG. 10.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. An electrolyte in communication with an anode and a cathode of a battery, the electrolyte comprising:
a eutectic solvent including ε-caprolactam (CPL), acetamide, imidazole, urea, amide, o-toluic acid, benzoic acid, furoic acid, quaternary ammonium type salts, or combinations thereof in equimolar concentration.

2. The electrolyte according to claim 1, further comprising:
an additional species including dioxolane (DOL) and dimethoxyethane (1,2 DME), bis(X-methoxyethoxy)ethane (TEGDME), lithium bis-(trifluoromethanesulfonyl)imide (LiTFSI), LiNO₃, or combinations thereof,
wherein the additional species is at about a 1:1 weight ratio with the euctectic solvent.

3. The electrolyte according to claim 1, wherein the eutectic solvent includes equimolar concentrations of CPL and acetamide.

4. The electrolyte according to claim 2, further comprising a sulfide.

5. The electrolyte according to claim 4, wherein the sulfide includes an alkali sulfide, an alkali polysulfide, or combinations thereof.

6. The electrolyte according to claim 5, wherein the sulfide includes Li₂S, Li₂S₂, Li₂S₃, Li₂S₄, Li₂S₅, Li₂S₆, Li₂S₇, Li₂S₈, Na₂S, Na₂S₃, Na₂S₄, Na₂S₅, Na₂S₆, Na₂S₇, Na₂S₈, or combinations thereof.

7. The electrolyte according to claim 6, wherein the sulfide is Li₂S.

8. The electrolyte according to claim 4, wherein the concentration of sulfide in the eutectic solvent is between about 0.2 M to about 0.4M.

9. The electrolyte according to claim 1, comprising a capacity of 1360 mAh·g⁻¹.

10. A battery comprising:
an anode;
a cathode; and
an electrolyte in communication with the anode and the cathode;
wherein the electrolyte comprises:
a eutectic solvent including ε-caprolactam (CPL), acetamide, imidazole, urea, amide, o-toluic acid, benzoic acid, furoic acid, quaternary ammonium type salts, or combinations thereof in equimolar concentration.

11. The battery according to claim 10, wherein the electrolyte further comprises:
an additional species including dioxolane (DOL) and dimethoxyethane (1,2 DME), bis(X-methoxyethoxy)ethane (TEGDME), lithium bis-(trifluoromethanesulfonyl)imide (LiTFSI), LiNO₃, or combinations thereof,
wherein the additional species is at about a 1:1 weight ratio with the eutectic solvent.

12. The battery according to claim 10, wherein the eutectic solvent includes equimolar concentrations of CPL and acetamide.

13. The battery according to claim 10, wherein the electrolyte further comprises a sulfide.

14. The battery according to claim 13, wherein the sulfide includes an alkali sulfide, an alkali polysulfide, or combinations thereof.

15. The battery according to claim 14, wherein the sulfide includes Li₂S, Li₂S₂, Li₂S₃, Li₂S₄, Li₂S₅, Li₂S₆, Li₂S₇, Li₂S₈, Na₂S, Na₂S₃, Na₂S₄, Na₂S₅, Na₂S₆, Na₂S₇, Na₂S₈, or combinations thereof.

16. The battery according to claim 15, wherein the sulfide is Li₂S.

17. The battery according to claim 13, wherein the concentration of sulfide in the eutectic solvent is between about 0.2 M to about 0.4M.

18. The battery according to claim 10, wherein at least one of the anode and cathode comprises a coating of TiO₂ nanoparticles.

19. A battery comprising:
an anode;
a cathode; and
an electrolyte in communication with the anode and the cathode;
wherein the electrolyte comprises:
a eutectic solvent including ε-caprolactam (CPL), acetamide, imidazole, urea, amide, o-toluic acid, benzoic acid, furoic acid, quaternary ammonium type salts, or combinations thereof in equimolar concentration;
a sulfide including an alkali sulfide, an alkali polysulfide, or combinations thereof; and
an additional species including dioxolane (DOL) and dimethoxyethane (1,2 DME), bis(X-methoxyethoxy)ethane (TEGDME), lithium bis-(trifluoromethanesulfonyl)imide (LiTFSI), LiNO₃, or combinations thereof, wherein the additional species is at about a 1:1 weight ratio with the eutectic solvent.

20. The battery according to claim 19, wherein the sulfide includes Li₂S, Li₂S₂, Li₂S₃, Li₂S₄, Li₂S₅, Li₂S₆, Li₂S₇, Li₂S₈, Na₂S, Na₂S₃, Na₂S₄, Na₂S₅, Na₂S₆, Na₂S₇, Na₂S₈, or combinations thereof.
